(19) United States
(12) Patent Application Publication
(10) Pub. No.: US 2004/0004352 A1
(43) Pub. Date: Jan. 8, 2004

(54) Guide with combined displays of multiple data

(76) Inventor: Richard P. Hockensmith, Harrisonville, PA (US)

Correspondence Address: Dwight G. Diehl, 117 South Juliana Street, Bedford, PA, 15522, US

(21) Appl. No.: 10/189,829

(22) Filed: Jul. 8, 2002

(51) Int. Cl. B42D 1/00; B42D 5/00

(52) U.S. Cl. 281/15.1

(57) ABSTRACT

A booklet having a plurality of interior pages containing hinging structures. The hinging structures permit portions of consecutive pages to be viewed simultaneously or to permit viewing of different portions of an interior page while viewing two charts attached to the booklet covers. The hinging structures allow multiple time periods or plural charts to be viewed simultaneously without the need of repeatedly turning between pages.

### BACKGROUND OF THE INVENTION

This invention relates to a handbook or booklet and in the preferred embodiment to a nutritional handbook having separate pages in a hinged arrangement for displaying various charts for foods, food values, and intake levels for display of consecutive days.

The use of printed materials and/or books to monitor and record data is well known in the art. In a typical nutritional booklet pages are hinged together at the center to form a booklet, each page containing a chart normally for one day to allow the user to record their intake quantities of particular food items as well as the nutritional values thereof. A user typically relies on the book for determining and recording each food item consumed during a day and relies on a chart to determine the nutritional values of that food item. In order to provide such nutritional values for each food item consumed, an amount of flipping between the particular page and the chart containing the food items is required. A user would need to refer to a nutritional chart to obtain the nutritional values associated with that food, then flip back to the page for the particular day in which the item is being recorded and record those nutritional values. The repetitive and inconvenient turning of pages or referring to a second chart is necessitated by the fact that one cannot simutaneously view the chart and the recording page at the same time.

While it is possible to have a chart separate from the nutritional booklet so that one can be viewing the chart at the same time completing the daily entries, this would require the booklet as well as a separate chart. Thus to carry the chart and the booklet with one while dining out or on a trip would be burdensome and inconvenient to accurately maintain one's nutritional records. There is thus a need in the prior art for a multi page nutritional booklet providing a simutaneous display and view of food items, the nutritional values of said food items, and the daily recording page necessary to record the food consumed by the user.

### SUMMARY AND OBJECTS OF THE INVENTION

It is accordingly an object of the present invention to overcome the difficulties of the prior art and to provide a booklet structured for simutaneous display of three columns or charts at the same time. It is a more specific object of the invention to provide a multi page, multi chart, nutritional booklet wherein the user can view a chart listing food items, the nutritional values for said food items, and the chart for the individual to record the food items consumed and the nutritional values associated with those items without the necessity of referring to a separate chart or turning pages to view these items. It is a further object of the invention to provide a simple structure enabling the user to view an entire day of foods, intakes, and nutritional values by simply folding a page in half without the necessity of referring to a chart or multiple pages at one time. In accordance with these and other objects of the invention there is thus provided a means for simutaneously exposing a chart having food items thereon, an intake chart, and nutritional values of the foods simutaneously and the intake page being hinged in the middle to allow for the viewing of a second food chart, intake chart, and nutritional values chart. Preferably, the present invention is a booklet having multiple pages hinged together at the center and allowing for multiple pages to be viewed at one time.

### BRIEF DESCRIPTION OF THE DRAWINGS

A brief description of the drawings is as follows:

FIG. 1 is a front view of the booklet showing the front hinges, back hinges, and page hinges.

FIG. 2 is a side view showing an interior page being folded or hinged to the left.

FIG. 3 is a front view showing the center page being folded or hinged to the right.

FIG. 4 is a view of an alternative design showing the center page being hinged to the right.

FIG. 5 is a side view of the alternative design as shown as shown in FIG. 4.

FIG. 6 is an alternative design showing 3 hinges on the front cover, 3 hinges on the rear cover, and more than 2 hinges on the interior page.

### DETAILED DESCRIPTION

The booklet of the present invention is a nutritional booklet 1, comprised primarily of a front cover means 2, a back cover means 3, center or interior pages 4 having a front side 4a and a back side 4b, nutritional charts 6, 8, and 10; and a plurality of hinges or hinge means 9, 13, 14, and 15. The front cover means 2 is hinged in the middle and is of a width twice that of the interior pages 4. The back cover means 3 which is hinged together with the front cover means 2 is further hinged in the middle and of a width twice that of the interior pages 4 and equal to the width of the front cover means 2. The front cover means 2 contains a front cover 5 and a nutritional chart 6 and the back cover means 3 contains a back cover 7 and a nutritional chart 8. Each of the interior pages 4 is hinged in the center thereof making them ¼ the width of the front and back cover means 2 and 3. Each of the interior pages 4 contains an intake chart 10 on each side 4a, 4b of the page. On each side of the page the intake charts 10 is comprised of two columns labeled A and B, thus each side of the interior pages 4 contains one A column 11 and one B column 12 chart for intake values. The nutritional chart 6 is a food chart which contains the list of foods that one would consume during a day. The chart 6 contains, but is not limited to, such foods as milk and yogurt, saturated and unsaturated fats, fruits and vegetables, meats, cheeses, eggs, breads, and starches. Each of these items lists a specific food and amount to be consumed which will correspond with values on the nutritional chart 8 which is a value chart. The value chart 8 has columns and entries that match the columns and entries on the foods chart 6, namely, the milk and yogurt, saturated and unsaturated fats, fruits and vegetables, meat, cheese, eggs, breads, and starches. The calorie, fat and cholesterol and carbohydrate values listed on these charts correspond to the quantities as listed on the foods charts.

The front cover means 2, when opened to its maximum width contains the identification of the booklet and the front cover 5 to the left of a front hinge 13, said hinge 13 being the middle of the cover means 2. To the right of the front hinge 13 is chart 5 containing two columns, the left hand column titled foods A and the right hand column titled foods B. These two columns constitute the foods chart 6. When the front cover means 2 is folded at hinge 13 the front cover 5 remains to the outside of the booklet 1 and the foods chart 6 is hinged to the inside of the booklet to cover one or more of the interior pages 4.

The back cover means 3 is of similar construction and when opened to its maximum width, on the right hand side of a back cover hinge 14, which is in the center of the back cover means 3, constitutes the exterior protective back cover 7 of the booklet with identifying information contained thereon. To the left of the back cover hinge 14 are two columns titled values A, to the far left, and values B, to the immediate left of the hinge 14. These two columns form the values chart 8 which contains the nutritional values that corresponds to the food quantities contained on the foods chart 6. When this back cover means 3 is hinged the back cover 7 remains on the outside of the booklet 1 while the values chart 8 is hinged to the interior and covers one or more of the interior pages 4.

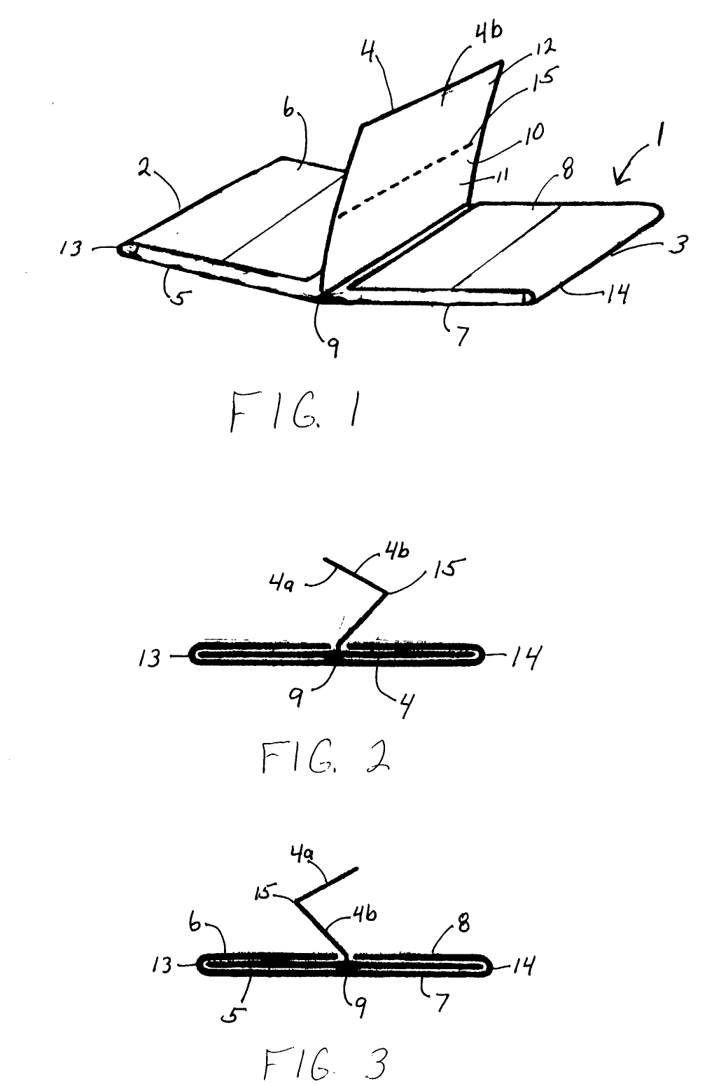

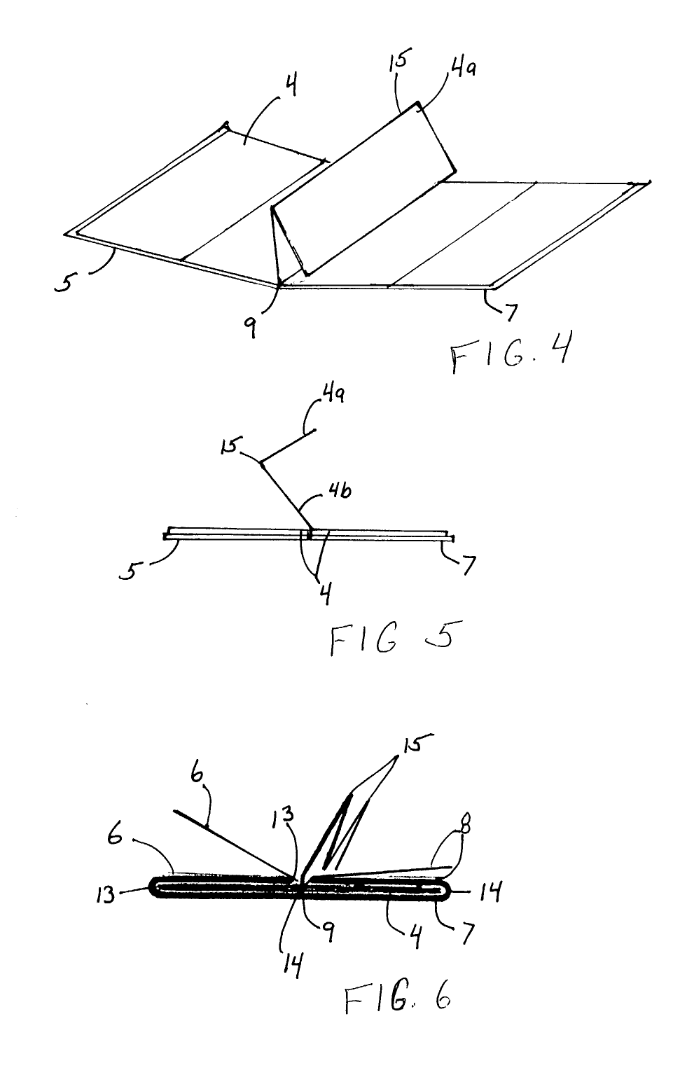

The interior pages 4 are hingedly attached to the center hinge 9 that connects the front cover means 2 to the back cover means 3. Numerous interior pages 4 are then contained between the front and back cover 5 and 7. Each interior page 4 is a two-sided page having two intake columns on each side 4a, 4b. Each side of the page contains one intake B column 12 and one intake A column 11. When opening the front cover 5 and looking at the front 4a of an interior page 4, the column to the left is intake B 12 and the column to the right is intake A 11. Upon turning the page to view the back 4b of the interior page 4, like columns are contained thereon, with intake column B 12 on the left and intake column A 11 on the right. A page hinge 15 in the center of each interior page 4 divides the intake column B 12 from the intake column A 11. This hinge 15 allows for each interior page to be folded in half and expose either only intake column B 12 or intake column A 11 at the user's preference. When an interior page is folded at the page hinge 15 from right to left, or back to front as shown in FIG. 2, intake column B 12 on the back side 4b will be first visible. Keeping the page folded as such and folding the page 4 toward the front cover means 2, one can view the column intake A 11 on the back 4b of the interior page 4. If the interior page is folded left to right as shown in FIG. 3 exposing the front of the interior page 4, initially intake column A 11 will be visible. Again, hinging or moving the page at the center hinge 9 that connects the front cover means 2 and the back cover means 3, column intake B 12 on the front 4a of the interior page 4 becomes visible.

The use or operation of the present invention is as follows: One would open the booklet 1 and unfold the front cover means 2 and utilize the foods chart 6 to cover the front page or pages to the interior of the booklet, having an unused interior page 4 showing intake columns to the right thereof. Next, the user would unfold the back cover means 3 and then hinge the values chart 8 to the interior of the booklet 1 covering all of the interior pages 4 except the one exposed immediately adjacent to those covered by the food chart 6. This then allows a user to have one interior page 4 visible between the front and rear covers 5 and 7 and specifically between the food chart 6 and the value chart 8. Then, for purposes of illustration, it would be assumed that none of the intake columns have been utilized. The user would then fold, at the page hinge 15, the interior page 4 from left to right (FIG. 3) and hinge the page 4 at the center hinge 9 between the front and back cover 5 and 7 to the left. By doing this, one would have visible to them, the foods A column on the foods chart 6 to the far left of the booklet, immediately adjacent thereto would be an unused intake A column 11, and immediately to the right of that contained on the values chart would be the values A column of the values chart 8. Thus one could readily record on the intake A column 11 what foods they consumed and in what quantities. Then, by comparing the quantity consumed to the quantities on the foods A column with the values on the value A column, the user could complete the nutritional value of the foods consumed, thus allowing one to complete a nutritional chart without the need of flipping pages or referring to a separate chart. If the foods the individual consumed are not contained on the foods A column, one would then simply fold the interior page at the center hinge 9 connecting the front and back cover means 2 and 3 to the right thus exposing the B columns 12. With the booklet in this position, to the far right would be the values B column, immediately to the left thereof would be the intake B column 12 and immediately adjacent to the left of the intake B column 12 would be the foods B column. This would then allow the user to again record the quantity of the foods consumed, compare that with the quantities listed in the foods B column and record the nutritional values of the foods consumed. Once one page is completed for one day, the next day the user would simply fold the interior page 4 at the page hinge 15, right to left (FIG. 2), exposing new unused intake A and intake B columns 11 and 12. Then, depending on whether the folded interior page 4 is hinged to the left or the right at the center hinge 9 connecting the front and back cover, one would expose and align intake column A 11 or B 12 with the appropriate foods column and the values column. After completing a second day and filling this side of this interior page, on the next day one would simply open the back cover and remove an interior page from under the values chart and place the completed page under nutritional chart 6 and again proceed to record the next days food consumption on the interior page 4 which has been folded in half at the page hinge exposing new intake columns A and B, 11 and 12.

This invention allows one to monitor and record their intake quantity of food and to easily and readily calculate the nutritional values associated with those foods and quantities without referring to separate charts or switching between a chart on a separate page and the intake chart. The size of the present invention also enables one to readily take the nutritional booklet with them when they go out for meals or are away from home for an extended period of time such as on work assignments or vacations. The interior of the booklet contains numerous interior pages and can be sized such that the intake pages would be sufficient to cover a one month period of time in the preferred embodiment, however, the booklet could contain less than a one month time frame or more than a one month time frame as desired by the user. Also inside the booklet 1 in addition to the intake pages 4 or columns 11 and 12, are included to the front of the pages, an introduction, a contents page, a short list of nutritional source information, and locations where nutritional information may be located or obtained from, as well as samples or examples of how to use the nutritional booklet. Additionally, after the interior pages 4, could be included an orientation and familiarization of nutrition simplified guide, a chart of weight and volume conversions, as well as, a monthly or yearly calendar, or any other information that one might deem useful to an individual possessing the nutritional booklet. The examples given regarding what other information or pages can be contained within the booklet, as well as the number of intake charts, are merely illustrational and not all of that information needs to be included, or more charts or information could be included without deviating from the novel concept of this invention.

The preferred embodiment of the present invention could be expanded to include additional charts and/or columns. This can be accomplished by adding one or more hinges 16 to the right side of the chart 6 and add one or more charts as shown in FIG. 6 and by adding the corresponding number hinges 17 and charts to left of chart 8. Additional columns or charts would also be added to the interior pages 4 by adding one or more hinges 18.

An alternative design, shown in FIGS. 4 and 5, would be to have the front cover means 2 and the back cover means 3 consist of only the front cover 5 and back cover 7. The interior pages 4 would contain periods of time, such as a day, one-half week or an entire week, on the front side 4a thereof. The operation of the present invention as a calendar booklet is as follows. The interior pages 4, for purposes of illustration, contain two weeks on the front side 4a thereof. Using the month of June as an example, the column 19 on the left side of the page hinge 15 is the first week of June and the column 20 on the right side of the page hinge 15 is the second week of June. On the front of the next consecutive interior page 4 the third and fourth weeks of June would be displayed, with the third week on the left of the page hinge 15 and the fourth week on the right of the page hinge 15, as viewed in FIG. 5.

To view the first two weeks of June one simply looks at the front of the interior page 4 containing said weeks as the first week passes and one wants to view the upcoming weeks the interior page 4 is folded at the page hinge 15 left to right while the interior page is hinged to the left at hinge 9. This now allows one to view the second, third and fourth weeks of June at the same time. As June passes and July approaches one would fold the interior page containing the third and fourth weeks of June at the page hinge 15, left to right, and the interior page 4 to the left at the center hinge 9, allowing one to view the fourth week of June and the first two weeks of July displayed on the next interior page 4, simultaneously.

As is evident to one of ordinary skill in the art, the interior pages 4 could contain days or partial weeks in place of whole weeks without departing from the inventive concept of the present invention.

I claim:

1. A booklet comprising:
a front cover means;
a back cover means;
a plurality of interior pages;
a center hinge interconnecting the front cover means and the back cover means;
the interior pages connected together and connected to the front cover means and back cover means at said center hinge; and
a portion of the interior pages have at least one page hinge contained therein.

2. A booklet as recited in claim 1, and further comprising:
said front cover means contains at least one nutritional chart and a front cover;
said back cover means contains at least one nutritional chart and a back cover; and
said portion of interior pages contain two uncompleted nutritional charts, one on each side and each chart consisting of two columns.

3. A booklet as recited in claim 1 and further comprising:
said front cover means has a width two times a width of the interior pages; and
said back cover means has a width two times a width of the interior pages.

4. A booklet as recited in claim 2 and further comprising:
said front cover means has a width two times a width of the interior pages; and
said back cover means has a width two times a width of the interior pages.

5. A booklet as recited in claim 4 and further comprising:
the nutritional chart of said front cover means is connected by a front cover hinge to the front cover;
the nutritional chart of said back cover means in connected to the back cover by a back cover hinge.

6. A booklet as recited in claim 1, and further comprising:
said portion of interior pages have at least two page hinges therein;
said front cover means includes a front cover and two nutritional charts and two front hinges; and
said back cover means includes a back cover and two nutritional charts and two back hinges.

7. A booklet as recited in claim 1, and further comprising:
said front cover means is comprised of a front cover;
said back cover means is comprised of a back cover;
said portion of interior pages each contain a plurality of time periods on the front thereof.

8. A booklet as recited in claim 7, and further comprising:
Said plurality of time periods contained on the portion of interior pages are each separated by hinge means.
